(19) United States
(12) Patent Application Publication
(10) Pub. No.: US 2008/0289547 A1
(43) Pub. Date: Nov. 27, 2008

(54) Crime Prevention Structure of Steel Door

(76) Inventors: Yuji Wakamatsu, Tokyo (JP); Kiyoshi Isokawa, Tokyo (JP); Akimitsu Suzuki, Tokyo (JP); Yoshitaka Abe, Tokyo (JP); Takashi Ishikawa, Tokyo (JP)

Correspondence Address: LADAS & PARRY, 5670 WILSHIRE BOULEVARD, SUITE 2100, LOS ANGELES, CA, 90036-5679, US

(21) Appl. No.: 11/662,579

(22) PCT Filed: Sep. 9, 2004
(86) PCT No.: PCT/JP04/13101

§ 371 Date: Sep. 27, 2007

(51) Int. Cl. E06B 3/76

(52) U.S. Cl. 109/76

(57) ABSTRACT

The present invention provides a crime prevention structure for a steel door. A steel door comprises an indoor panel, an outdoor panel, a sound-insulating core filled in a space formed between inner surfaces of the panels, and a high hardness metal plate that is thicker than plate thickness of the panels wherein the metal plate is provided between the sound-insulating core and an entire inner surface area, except sections for mounting door components, of at least one of the panels. In one preferred aspect, the metal plate is provided at the entire inner surface area, except portions for mounting door components, of the indoor panel.

### TECHNICAL FIELD

The present invention relates to a steel door used as a swinging door provided on a doorway of an apartment block or high-rise building, and more particularly to a crime prevention structure for a steel door.

### BACKGROUND ART

Conventionally, as for a steel door with a specified depth comprising an indoor panel and an outdoor panel, a crime prevention function adopting combination of a locking structure provided in a handle section and the other one or more locking structures is known. The majority of “break-ins and burglaries”, which have been on the increase in recent years, are carried out by forcing entry from a doorway such as an entrance provided with a steel door, and this method of forced entry is generally by means of “cam feed unlocking” and “bypass unlocking”, as well as lock picking to unlock by inserting a specialized tool in place of a key, but these methods of forcing entry are generally abandoned if they take five minutes or more, and on the basis of this fact development has been carried out for a new crime prevention structure capable of providing resistance to various methods of forcing entry.

The above described methods of forcing entry in a robbery are characterized by so-called “intellectual criminal” behavior to carry out unlocking by deftly manipulating a locking mechanism, but in recent years other than these methods, methods of forcing entry have started to appear that are more forceful and brutal, such as destroying a locking mechanism using an electric or hand operated drill, or drilling a hole in a door surface of sufficient size to be able to put a hand therethrough, and then unlocking the door by reaching through the hole, and entering inside a room. If an indoor panel and an outdoor panel are made thick to resist these intrusions, problems such as lowering of press working ability of a manufacturing process, and restrictions to design characteristics such as shape, design, etc. would arise. Therefore, there has been a serious demand for a steel door that ensures manufacturing efficiency of the steel door, and has a stronger crime prevention function.

Also, with a door that is provided at an opening by means of a pivot hinge, there is a possibility that the pivot hinge may be destroyed as it is exposed at the top and bottom of the door. If the pivot hinge is broken, there is a problem that it becomes possible to remove the door from the opening, and even if the door is locked the crime prevention characteristics are degraded.

### DISCLOSURE OF THE INVENTION

An object of the present invention is to provide a crime prevention structure for preventing forced entry into a room by destroying a door.

Another object of the present invention is to provide a crime prevention structure for a steel door having superior crime prevention characteristics that can sufficiently resist forceful and brutal invasions without impairing the design features, such as shape and design.

A still further object of the present invention is to provide a crime prevention structure that can prevent forced entry into a room, even in the event that a pivot hinge by which the door is hung in an opening is destroyed.

The present invention relates to a steel door comprising an indoor panel, an outdoor panel, a sound-insulating core filled in a space formed between inner surfaces of the panels, and a high hardness metal plate that is thicker than plate thickness of the panels wherein the metal plate is provided between the sound-insulating core and the entire inner surface area, except sections for mounting door components, of at least one of the panels.

In one preferred aspect, the metal plate is provided at the entire inner surface area, except portions for mounting door components, of the indoor panel.

In one preferred aspect, the door is swingably provided at an opening by means of the pivot hinge, a removal prevention member is provided at a hinge-side side portion the door and projects towards a hinge-side side portion of an opening, and a projecting piece is provided at the hinge-side side portion of the opening for covering the removal prevention member from an outdoor side.

In a further preferred aspect, the projecting length of the removal prevention member from the steel door is set longer than the sum of respective gaps between the both side sections of the steel door and both side sections of the opening. In a further preferred aspect, a gap between a projecting end section of the removal prevention member and a hinge-side side portion of the opening is set shorter than an engagement length of a lock member provided at a lock-side side section of the steel door with a building frame. In another aspect, the projecting length of the removal prevention member from the steel door is set longer than the sum of respective gaps between the both side sections of the steel door and both side sections of the opening, and a gap between a projecting end section of the removal prevention member and a hinge-side side portion of the opening is set shorter than an engagement length of a lock member provided at a lock-side side section of the steel door with a building frame.

The present invention can provide a steel door in line with consumer demand, capable of providing a required and sufficient crime prevention structure, even against forceful and brutal forced entry, such as destroying a locking mechanism using an electric or hand operated drill, or drilling a hole in a door surface of sufficient size to be able to put a hand therethrough, and then unlocking the door by reaching through the hole, and entering inside.

With a structure where a metal plate extends over the entire inner surface, except sections for mounting door components, of the indoor panel, it is possible to provide a steel door with which ornamental choices of the outdoor panel, which is an important consideration in the design, is ensured, and with which the range of product choice is expanded by increasing product worth and features of a steel door, while also providing a crime prevention function.

A removal prevention member provided on the steel door, and with a removal prevention member covered by a projecting piece provided in the opening, it is possible to have a door with superior crime prevention characteristics, where it is possible to prevent the steel door being removed even if a pivot hinge is destroyed.

### BRIEF DESCRIPTION OF THE DRAWINGS

FIG. 1 is an overall front elevation of a steel door;

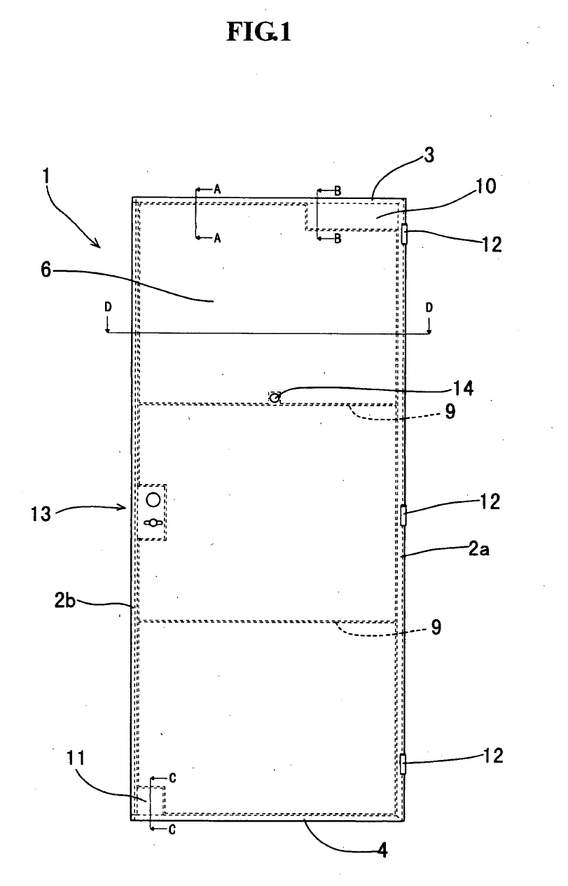

FIG. 2 is an overall front view of a steel door in a state with an outdoor panel removed;

FIG. 3A is a cross section along line A-A;

FIG. 3B is a cross section along line B-B;

FIG. 3C is a cross section along line C-C;

FIG. 4 is a cross section along line D-D;

FIG. 5A is a horizontal cross section of another example of a steel door;

FIG. 5B is an enlarged cross section of the steel door of FIG. 5A;

FIG. 6 is a partial plan cross section of a steel door;

FIG. 7 is a horizontal cross section of a steel door; and

FIG. 8 is a partial horizontal cross section of a door of another embodiment.

### BEST MODE FOR CARRYING OUT THE INVENTION

Preferred embodiments of the present invention will now be described in detail based on the attached drawings. In the drawings, reference numeral 1 is a steel door provided in an entrance of a house. The steel door 1 comprises a metal rectangular frame 5 formed from left and right members 2 and top and bottom members 3, 4, a metallic outdoor panel 6 and a metallic indoor panel 7. The metallic panels 6, 7, each having a specified thickness (in the embodiment, a thickness of 0.6 mm), are provided in the rectangular frame and extend over the entire front and back door faces. End edges of the each of the panels 6, 7 positioned at a periphery of the metallic rectangular frame 5 are bent in the depth direction of the door and the steel door 1 is formed by securing the bent edges of the panels to the end surfaces of the metal rectangular frame 5 by rivets 8.

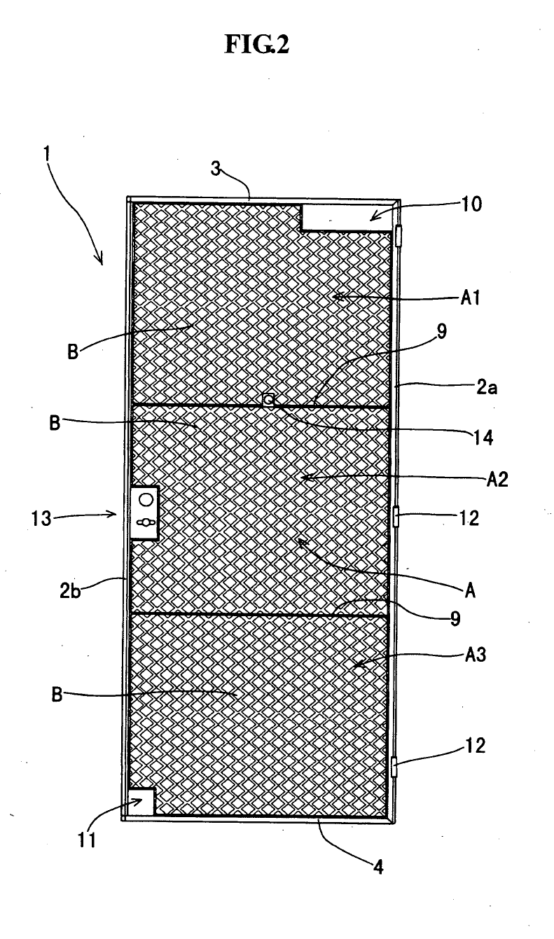

As shown in FIG. 2, three sound-insulating cores B having a sound-insulating function are filled into spaces A1, A2 and A3 via abutments 9, 9 covering almost the entire space A, except a section 10 for mounting a door closer positioned adjacent to a hinge-side of the top member 3, a section 11 for mounting hardware for door stop positioned adjacent to a lock-side of the bottom member 4, and a lock mounting section 13 that will be described later.

Reference numeral 12 designates hinges provided at three vertical positions of the hinge-side vertical member 2, reference numeral 13 designates the lock mounting section provided in the space section A2 adjacent to the lock-side vertical member 2, and reference numeral 14 designates a see-through lens mounting section provided in the middle of the upper space section A1.

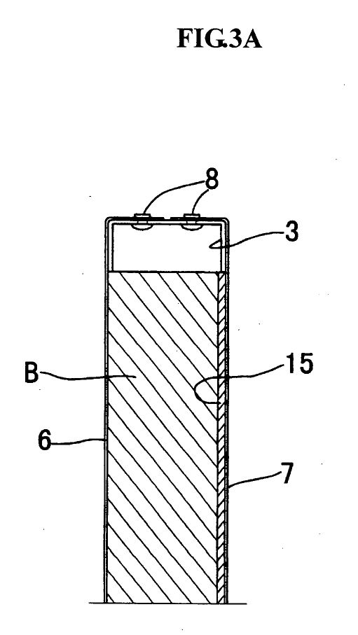

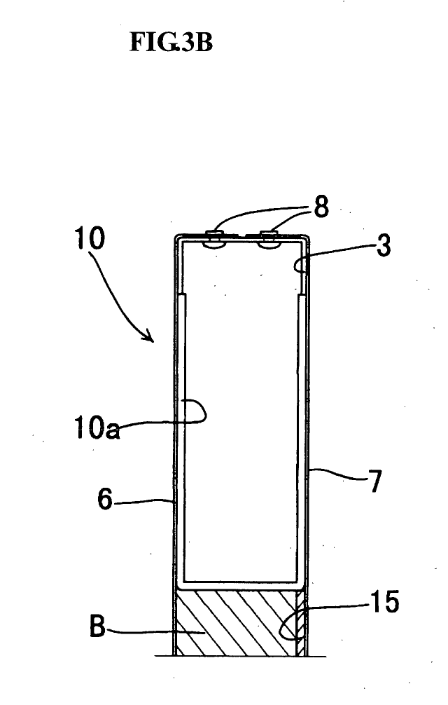

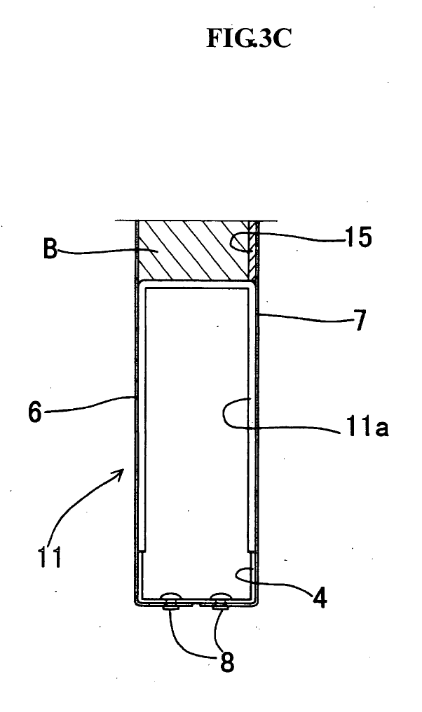

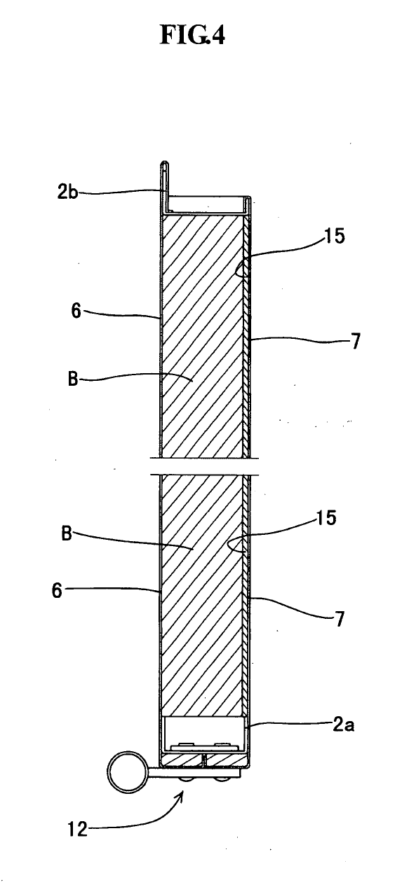

Here, as shown in FIG. 3 and FIG. 4, with the present invention, in particular, between the inner surface of the indoor panel 7 and the sound-insulating core B, a high hardness metal plate 15 that is thicker than the plate thickness of the indoor panel 7 is attached and extended over the inner surface of the panel 7 by means of an adhesive (not shown).

The metal plate 15 is formed from austenite stainless steel (in this embodiment using SUS304 with a plate thickness of 1.5 mm), and is provided so as to cover the entire inner surface of the indoor panel 7, except respective mounting positions of the door components, such as the liner section 10a of the door closer mounting section 10, the liner section 11a of the hardware mounting section 11, and the lock mounting section 13. Ideally, it is more desirable from the point of view of crime prevention to have a structure where a metal plate 15 is respectively provided on the inner surfaces of both the indoor panel 7 and the outdoor panel 6. However, taking into consideration increase in weight of the steel door 1 and increase in manufacturing cost, as well as the fact that design and appearance of the outdoor panel 6 are important so that the inner surface of the ornamentally-manufactured outdoor panel 6 is not made flat, the metal plate 15 may not be suitable for the inner surface of the outdoor panel 6. With this embodiment the required and sufficient crime prevention function is imparted to the steel door 1 by providing the metal plate 15 to the indoor panel 7 side of the steel door 1.

In a building opening to which the steel door 1 of the present invention is provided, even when an attempt is carried out to break-in using an electric or hand operated drill, it may be possible to break through the outdoor panel 6 and the sound-insulating core B in a relatively short time, but breaking through indoor panel 7 ahead was inhibited by the presence of the steel plate 15 extending over the indoor panel 7, resulting in the intruder giving up their intrusion attempt, and it is possible to prevent a forceful break-in.

With the steel door 1 adopting the indoor panel 6 and outdoor panel 7 having a plate thickness of 0.6 mm shown with this embodiment, and the steel plate 15 formed from austenite stainless steel (SUS304) having a plate thickness of 1.5 mm, it was found by experimentation that it was not possible to break through from the outdoor side to the indoor side using a hand operated drill.

As the metal plate 15, instead of SUS304 austenite stainless steel plate it is also possible to use high hardness martensite stainless steel (SUS410) that has been subjected to heat treatment such as tempering, or other austenite stainless steel (SUS301) that has been given high hardness by cold forging, and in this way it is possible to impart an advantageous crime prevention structure to the steel door 1 that resists attempts at breaking in by drilling a hole with an electric drill and hand-operated drill.

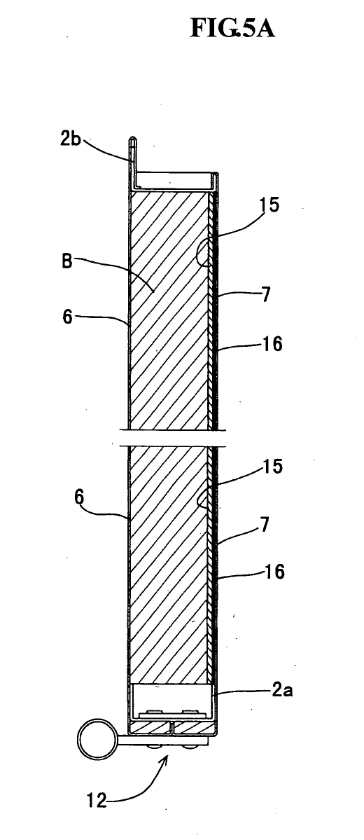

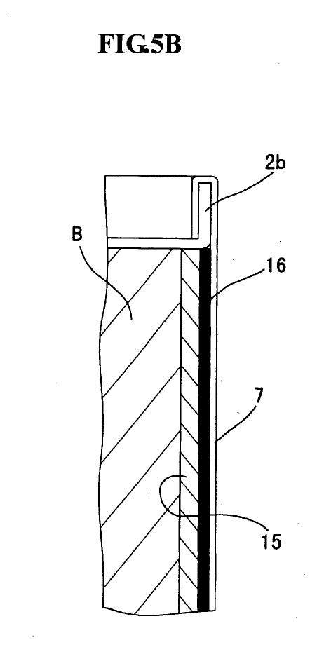

FIG. 5 shows another the structure of a steel door 1. According to the steel door 1 of the foregoing embodiment, when the steel plate 15 is provided between the entire inner surface, except the section 10 for mounting a door closer, the section 11 for mounting hardware and the lock mounting section 13, of the indoor panel 7 and the sound-insulating core B, the metal plate 15 is provided and extends over the entire inner surface of the indoor panel 7 by means of viscoelastic polymer resin.

With this structure, a viscoelastic polymer resin (polyethylene resin is adopted in this embodiment) is adhesively fixed between the steel plate 15 and the indoor panel 7 to give a function as a vibration damping plate, and with this type of configuration, it is possible to attenuate vibration of the steel door 1 that contacts the door frame when the door is opened or closed, particularly at the time of automatic closing of the door by a door closure, and it is possible to reduce the amount of ambient noise in combination with the sound-insulating effect of the sound-insulating core B filled inside the steel door 1.

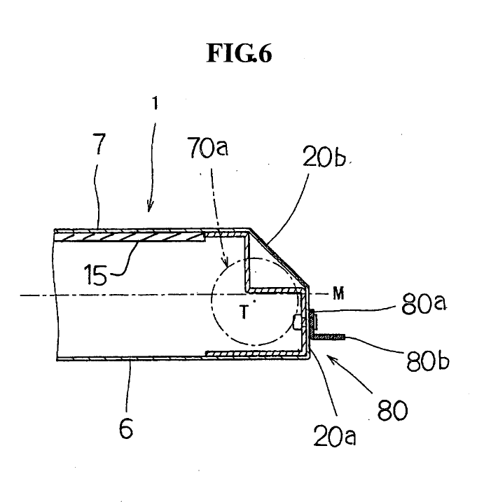

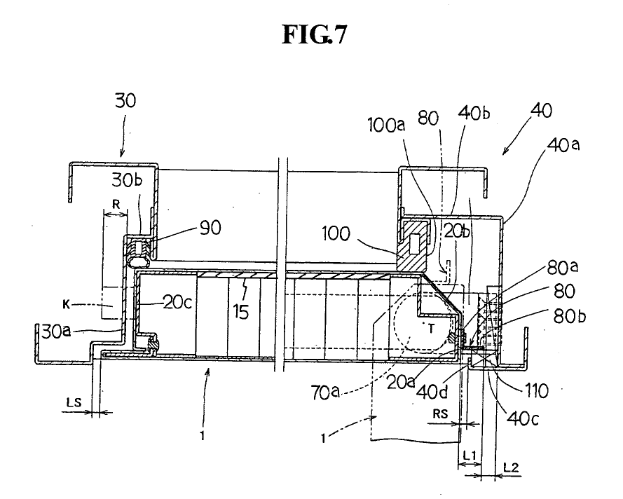

An example of a swinging door using the steel door 1 of the present invention will be described based on FIG. 6 to FIG. 8. One side portion of the steel door 1 is swingably attached at one side of a door frame constituting an opening. The door frame is comprised of left and right vertical jambs 30 and 40, and upper and lower horizontal members. In FIG. 7, there is a lock side jamb 30 on the left side, and a hinge side jamb 40 on the right side. The steel door 1 is swingably attached to the door frame (building frame side) with a pivot 70a as a fulcrum. An axis T of the pivot 70a that is the swinging fulcrum of the steel door 1 is displaced to the outdoor side from the center line M of thickness of the steel door 1.

The steel door 1 comprises a removal prevention member 80 provided at an outdoor side half section of the hinge-side side section 20a along substantially the whole vertical length thereof. By providing the removal prevention member 80 along the entire length in the vertical direction of the hinge-side side section 20a of the steel door 1, it is possible to increase the crime prevention characteristics by making an act of destruction more difficult to carry out, as well as taking longer, in spite of an attempt to damage the removal prevention member 80 that can be reached from the outside through a hinge-side gap RS. The removal prevention member 80 is formed by bending a metallic plate in an L-shape, with one leg 80a of the L-shape being fixed to a steel door hinge-side side section 20a using screws. The other leg 80b of the removal prevention member 80 projects from the steel door hinge-side side section 20a towards a side end section 40a of the hinge-side door jam 40 in the width direction of the door 1.

A projecting piece 40c projecting towards the lock-side side (left side) of the door is integrally provided on at an outdoor end section of the side end section 40a of the hinge-side jamb 40, with the projecting section 40c and the removal prevention member 80 overlapping, and the projecting end edge of the removal prevention member being covered by the projecting piece 40c. An engagement receiving piece 40d is integrally formed with the projecting end edge section of the projecting piece 40c, projecting towards the removal prevention member 80 side (indoor side), thereby the gap between the removal prevention member 80 and the engagement receiving piece 40d is made small, making insertion of a tool or the like difficult and thus increasing the crime prevention characteristics. Also, the removal prevention member 80 is provided at an outdoor half section of the hinge-side side section 20a of the steel door, as described previously. By positioning the removal prevention member 80 at the outdoor side, it is made difficult to insert a tool such as a bar between the hinge-side side section 20a and the projecting piece 40c. Also, K designates a latch bolt (locking member) provided between the lock-side side section 20c of the steel door 1 and the lock side jamb 30, and the latch bolt K projects to a lock side jamb 30 in accordance with an locking operation to engage with a lock receiving section (not shown) formed in the lock side door jamb side section 30a (building frame side).

In a state where the steel door 1 is hung in a door frame, a gap of a predetermined size is formed between the steel door 1 and the door jamb, at both sides. With this embodiment, gaps formed to the left and right, that is, a gap (lock side gap) LS between the hinge-side side section 20c of the steel door 1 and the lock side door jamb side section 30a, and a gap (hinge side gap) RS between the hinge-side side section 20a of the steel door 1 and the projecting section 40c of the hinge-side door jamb 40, are provided so as to be the same size, and arranged so as to give the best appearance from the outdoor side. A length L1 to which the removal prevention member 80 provided on the steel door 1 projects from the hinge-side side section 20a is set longer than a sum length of the two gaps LS, RS of the steel door (L1>LS+RS), and a length to which the removal prevention member 80 is covered by the projection section 40c of the door jamb 40 is set longer than the lock side gap LS. In this way, even if the pivot hinge 70 is destroyed, the connection between the steel door 1 and the door jamb is broken, and the steel door 1 is forced to the lock-side side door jamb 30 in an attempt to remove it, the removal prevention member 80 engages with the hinge-side door jamb projecting piece 40c and it is possible to prevent the steel door 1 being removed from the door frame.

Further, with this embodiment, an opposed gap L2 between the projecting edge of the removal prevention member 80 and the side piece 40a of the hinge side door jamb 40 is set so that it is shorter than the engagement length R of the latch bolt K to the side section 30a of the lock side door jamb 30 (L2<R). In this way, even if the pivot hinge 70 is destroyed, the connection between the steel door 1 and the door jamb is broken, and the steel door 1 is forced to the hinge side door jamb 40 in an attempt to remove it, the engagement between the latch bolt K and the lock side door jamb side piece 30a is not removed and it is possible to prevent the steel door 1 being removed from the door frame.

When the steel door 1 is swung to the outdoor side about the axis T of the pivot 70a as a rotational center, the removal prevention member 80 provided at the side section 20a of the hinge-side of the steel door 1 swings together with the steel door 1. The hinge side door jamb 40 in this embodiment has the side section 40a longer in a depth direction of the door 1 compared to the side section 30a of the lock side door lamb 30, and the door contact section 40b formed longer in the width direction of the door compared to the door contact section 30b of the door jamb 30, to avoid interference with the removal prevention section 80. The removal prevention member 80 is provided at an outdoor half section of the steel door 1, and an axis T of the pivot hinge 70 is provided displaced further to the outdoor side than the centerline of the thickness of the steel door 1. In this way, a turning radius of the outdoor section of the hinge side of the steel door is made small, and also the turning radius of the removal prevention member 80 can be made small.

Reference numerals 90 and 100 designate sealing members for sealing between the door jamb and the indoor side surface of the steel door 1 along the entire length in the lateral direction and vertical directions, and compared to the sealing member 90 provided at the lock side door jamb 30 and the upper and lower door jambs, the sealing member 100 provided at the hinge side door jamb 40 is formed longer in a depth direction of the door, by the length in which the side sections 40a run in the depth direction of the door. The mounting position of the sealing member 100 in the hinge side door jamb 40 is such that the hinge-side side section 100a of the sealing member 100 and the axis T of the pivot 70a of the pivot hinge 70 are provided on substantially the same straight line.

With this embodiment, by providing the removal prevention member 80 at an outdoor side half section side of the hinge-side side section 20a, the steel door 1 is prevented from interfering with the sealing member 100 when being opened. The hinge-side side section 20a of the steel door 1 is formed at an indoor side section, an indoor side corner section is cut away to form an inclined surface 20b, and when the steel door is swung, deformation of the sealing member 100 is as large as just required, and swinging movement of the steel door can be made smooth, which improves the durability of the sealing member 100. A sealing member 110 is provided on the projecting piece 40c integrally provided on the hinge side door jamb 40, along the entire length in the vertical direction for sealing between the outdoor side of the removal prevention member 80 and the door jamb 40. In this way, at the side section 20a side of the hinge side of the steel door 1, sealing characteristics are improved by the two sealing members 100 and 110 respectively coming into contact with the steel door 1 and the removal prevention member 80.

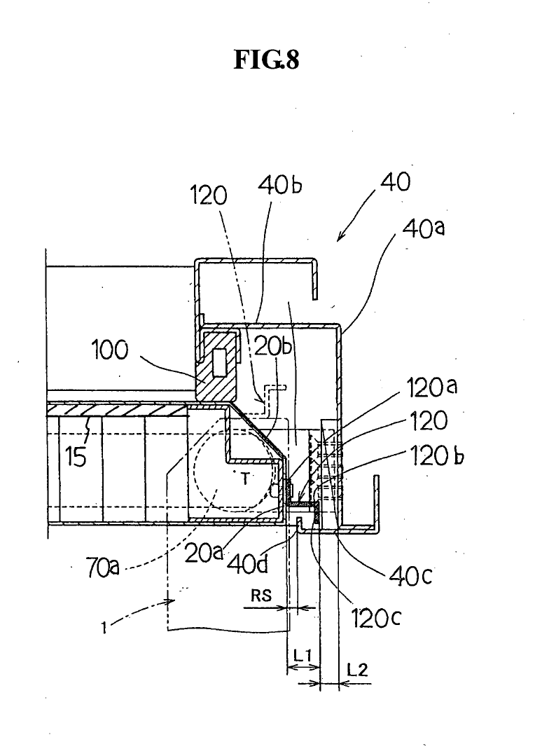

The present invention is not limited to the above described embodiment, and it is can also be constructed as a second embodiment shown in FIG. 8. A removal prevention member 120 of the second embodiment is formed in a crank shape, with an engagement piece 120c projecting towards the projection piece 40c provided on the hinge side door jamb integrally formed with a projecting edge section of a leg 120b that projects to the hinge side door jamb 40, of the pair of leg pieces 120a and 120b. The engagement piece 120c and an engagement receiving piece 40d provided at a projecting tip edge of the projecting piece 40c are arranged such that they are oppositely overlapped. In this manner, in the event of the pivot hinge 70 being damaged and an attempt being made to remove the steel door 1, the engagement piece 120c and the engagement reception piece 40d are engaged, and it is made difficult to remove the steel door 1.

### INDUSTRIAL UTILIZATION

A steel door of the present invention can be used as a swinging door having superior crime prevention characteristics.

What is claimed is:

1. A crime prevention structure for steel door comprising:
a steel door having an indoor panel and an outdoor panel, and a sound-insulating core filled in a space formed between inner surfaces of said panels; and
a high hardness metal plate being thicker than plate thickness of said panels wherein said metal plate is provided between said sound-insulating core and the entire inner surface area, except sections for mounting door components, of at least one of said panels.

2. The structure of claim 1, wherein said metal plate is provided at the entire inner surface area, except sections for mounting door components, of the indoor panel.

3. The structure of claim 1, wherein said door is swingably provided at an opening by pivot hinges,
said crime prevention structure further comprising:
a removal prevention member provided at a hinge-side side section of the door and projecting towards a hinge-side side section of the opening; and
a projecting piece provided at the hinge-side side section of the opening for covering the removal prevention member from an outdoor side.

4. The structure of claim 3, wherein the projecting length of the removal prevention member from the steel door is set longer than the sum of respective gaps between the both side sections of the steel door and both side sections of the opening.

5. The structure of claim 3, wherein a gap between a projecting end section of the removal prevention member and a hinge-side side portion of the opening is set shorter than an engagement length of a lock member provided at a lock-side side section of the steel door with a building frame.

6. The structure of claim 3, wherein the projecting length of the removal prevention member from the steel door is set longer than the sum of respective gaps between the both side sections of the steel door and both side sections of the opening, and wherein a gap between a projecting end section of the removal prevention member and a hinge-side side portion of the opening is set shorter than an engagement length of a lock member provided at a lock-side side section of the steel door with a building frame.
